(19) United States
(12) Patent Application Publication
(10) Pub. No.: US 2018/0203784 A1
(43) Pub. Date: Jul. 19, 2018

(54) MANAGEMENT COMPUTER AND PERFORMANCE DEGRADATION SIGN DETECTION METHOD

(71) Applicant: HITACHI, LTD., Chiyoda-ku (JP)

(72) Inventors: Jun MIZUNO, Tokyo (JP); Takashi TAMESHIGE, Tokyo (JP)

(73) Assignee: HITACHI, LTD., Tokyo (JP)

(21) Appl. No.: 15/743,516

(22) PCT Filed: Mar. 28, 2016
(86) PCT No.: PCT/JP2016/059801

§ 371 Date: Jan. 10, 2018

(51) Int. Cl. G06F 11/34; G06F 9/455; G06F 11/20; G06F 11/30; G06F 11/14

(52) U.S. Cl. CPC G06F 11/3409; G06F 9/45558; G06F 11/2023; G06F 2201/815; G06F 11/1438; G06F 2009/4557; G06F 11/301

(57) ABSTRACT

A management computer detecting signs of performance degradation even when virtual computing units are generated and destroyed repeatedly over a short period of time. The management computer manages an information system including one or more computers and one or more virtual computing units virtually implemented on the one or more computers, while detecting signs of degradation of the performance. The management computer acquires operating information from all virtual computing units belonging to one or more autoscaling groups, which generates from the operating information, reference values, each of which is used for detecting signs of degradation of the performance of one of the one or more autoscaling groups, and detects signs of degradation of the performance in each autoscaling group using both the reference values generated and the operating information about the virtual computing units as acquired.

### TECHNICAL FIELD

The present invention relates to a management computer and a performance degradation sign detection method.

### BACKGROUND ART

Recent information systems realize so-called autoscaling which involve increasing virtual machines or the line in accordance with an increase in load. In addition, since the dissemination of containerization technology has resulted in reduced instance deployment times, targets of autoscaling have widened to include scale-in in addition to scale-out. Therefore, operations in which scale-in and scale-out are repeated in a short period of time are being started.

The performance of an information system may degrade as operation continues. In consideration thereof, in order to accommodate degradation of the performance of an information system, a technique for detecting a sign of performance degradation using a baseline having learned a normal state of the information system is proposed (PTL 1). In PTL 1, in consideration of the fact that configuring a threshold for performance monitoring is difficult, a baseline is generated by statistically processing normal-time behavior of the information system.

### CITATION LIST

### Patent Literature

### [PTL 1]

Japanese Patent Application Laid-open No. 2004-164637

### SUMMARY OF INVENTION

### Technical Problem

Since load applied to an information system has periodicity, creating a baseline usually requires a week's worth or more of operating information. However, since scale-in and scale-out repetitively occur in the latest server virtualization technology, an instance that is a monitoring target of performance degradation is destroyed in a short period of time. Since operating information necessary for generating a baseline (for example, a week's worth of operating information) cannot be obtained, a baseline cannot be generated.

This is not limited to autoscaling using containerization technology but is a problem that may also occur in autoscaling using a virtual machine or a physical machine when scale-in and scale-out are frequently repeated. As described above, with conventional art, since a baseline cannot be generated, a difference from normal behavior cannot be discovered and a sign of degradation of the performance of an information system cannot be detected.

The present invention has been made in consideration of the problem described above and an object thereof is to provide a management computer and a performance degradation sign detection method capable of detecting a sign of performance degradation even when virtual computing units are generated and destroyed repeatedly over a short period of time.

### Solution to Problem

In order to solve the problem described above, a management computer according to the present invention is a management computer which detects and manages a sign of performance degradation of an information system including one or more computers and one or more virtual computing units virtually implemented on the one or more computers, the management computer including: an operating information acquisition unit configured to acquire operating information from all virtual computing units belonging to an autoscaling group, the autoscaling group being a unit of management for autoscaling of automatically adjusting the number of virtual computing units; a reference value generation unit configured to generate, from each piece of the operating information acquired by the operating information acquisition unit, a reference value that is used for detecting a sign of performance degradation for each autoscaling group; and a detection unit configured to detect a sign of degradation of the performance of each virtual computing unit using both the reference value generated by the reference value generation unit and the operating information about the virtual computing unit as acquired by the operating information acquisition unit.

### Advantageous Effects of Invention

According to the present invention, a reference value for detecting a sign of performance degradation can be generated based on operating information of all virtual computing units in a autoscaling group, and whether or not there is a sign of performance degradation can be detected by comparing the reference value with operating information. As a result, reliability of an information system can be improved.

### BRIEF DESCRIPTION OF DRAWINGS

FIG. 1 is an explanatory diagram showing a general outline of the present embodiment.

FIG. 2 is a configuration diagram of an entire system including an information system and a management computer.

FIG. 3 is a diagram showing a configuration of a computer.

FIG. 4 is a diagram showing a configuration of a replication control unit.

FIG. 5 is a diagram showing a configuration of a table, stored in a replication control unit, for managing an autoscaling group.

FIG. 6 is a flow chart representing an outline of processing of a life-and-death monitoring program that runs on a replication control unit.

FIG. 7 is a flow chart representing an outline of processing of a scaling management program that runs on a replication control unit.

FIG. 8 is a diagram showing a configuration of a management server.

FIG. 9 is a diagram showing a configuration of a table, stored in a management server, for managing container operating information.

FIG. 10 is a diagram showing a configuration of a table, stored in a management server, for managing total amount operating information.

FIG. 11 is a diagram showing a configuration of a table, stored in a management server, for managing average operating information.

FIG. 12 is a diagram showing a configuration of a table, stored in a management server, for managing a total amount baseline.

FIG. 13 is a diagram showing a configuration of a table, stored in a management server, for managing an average baseline.

FIG. 14 is a flow chart representing an outline of processing of an operating information acquisition program that runs on a management server.

FIG. 15 is a flow chart representing an outline of processing of a baseline generation program that runs on a management server.

FIG. 16 is a flow chart representing an outline of processing of a performance degradation prediction program that runs on a management server.

FIG. 17 is a flow chart representing an outline of processing of a countermeasure implementation program that runs on a management server.

FIG. 18 is a diagram showing a configuration of a management server according to a second embodiment.

FIG. 19 is a diagram showing a configuration of a table, stored in a management server, for managing a computer in an information system.

FIG. 20 is a diagram showing a configuration of a table, stored in a management server, for managing a group in an autoscaling group divided by grades of computers.

FIG. 21 is a flow chart representing an outline of processing of a group generation program that runs on a management server.

FIG. 22 is a diagram showing an overall configuration of a plurality of information systems in a failover relationship according to a third embodiment.

### DESCRIPTION OF EMBODIMENTS

Hereinafter, an embodiment of the present invention will be described with reference to the drawings. As will be described later, the present embodiment enables a sign of performance degradation to be detected in an environment where, due to frequently repeated scale-in and scale-out, a monitoring target instance is destroyed before a baseline is generated. A virtual computing unit is not limited to an instance (a container) and may instead be a virtual machine. In addition, the present embodiment can also be applied to a physical computer instead of a virtual computing unit.

In the present embodiment, all monitoring target instances belonging to a same autoscaling group will be spuriously assumed to be a same instance. In the present embodiment, a baseline (a total amount baseline and an average baseline) as a “reference value” is generated from operating information of all instances in the same autoscaling group.

In the present embodiment, a determination of detection of a sign of performance degradation is made when a total amount of operating information (total amount operating information) of instances belonging to an autoscaling group is compared with a total amount baseline and the total amount operating information deviates from the total amount baseline. In the present embodiment, scale-out is instructed when a total amount baseline violation is discovered in the information system. Accordingly, since the number of instances belonging to the autoscaling group having violated the total amount baseline increases, performance is improved.

In the present embodiment, a determination of detection of a sign of performance degradation is also made when an average of operating information of the respective instances belonging to an autoscaling group is compared with an average baseline and the operating information of each instance deviates from the average baseline. In this case, the instance in which is detected the average baseline violation is discarded and a similar instance is regenerated. Accordingly, performance of the information system is restored.

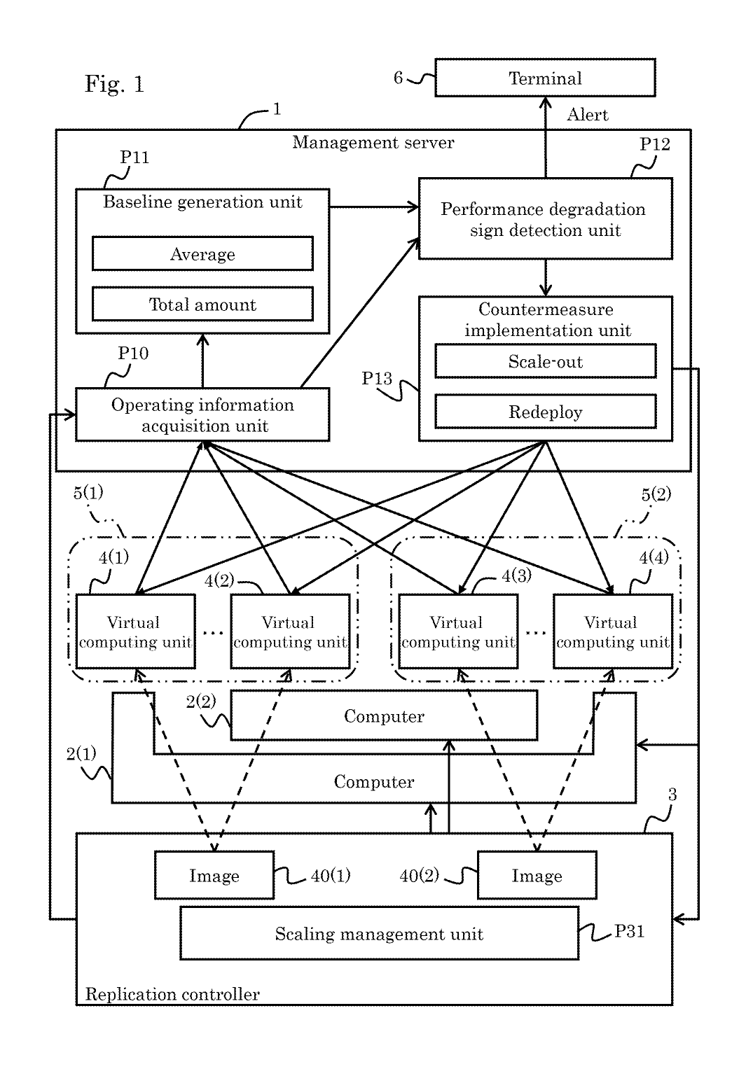

FIG. 1 is an explanatory diagram showing a general outline of the present embodiment. It is to be understood that the configuration shown in FIG. 1 represents an outline of the present embodiment to an extent necessary for understanding and implementing the present invention and that the scope of the present invention is not limited to the illustrated configuration.

A management server 1 as a “management computer” monitors a sign of performance degradation of the information system and implements a countermeasure when detecting a sign of performance degradation. For example, the information system includes one or more computers 2, one or more virtual computing units 4 implemented on the one or more computers 2, and a replication controller 3 which controls generation and destruction of the virtual computing units 4.

For example, the virtual computing unit 4 is configured as an instance, a container, or a virtual machine and performs arithmetic processing using physical computer resources of the computer 2. For example, the virtual computing unit 4 is configured to include an application program, middleware, a library (or an operating system), and the like. The virtual computing unit 4 may run on an operating system of the computer 2 as in the case of an instance or a container or run on an operating system that differs from the operating system of the computer 2 as in the case of a virtual machine managed by a hypervisor. The virtual computing unit 4 may be paraphrased as a virtual server. In the embodiment to be described later, a container is used as an example of the virtual computing unit 4.

Moreover, in the drawing, bracketed numerals are added to reference signs to enable elements that exist in plurality such as the computer 2 and the virtual computing unit 4 to be distinguished from each other. However, when a plurality of elements need not particularly be distinguished from each other, the elements will be expressed while omitting the bracketed numerals. For example, the virtual computing units 4 (1) to 4 (4) will be referred to as the virtual computing unit 4 when the virtual computing units need not be distinguished from each other.

The replication controller 3 controls generation and destruction of the virtual computing units 4 in the information system. The replication controller 3 stores one or more images 40 as “startup management information”, and generates a plurality of virtual computing units 4 from the same image 40 or destroys any one of or any plurality of virtual computing units 4 from the plurality of virtual computing units 4 generated from the same image 40. The image 40 refers to management information which is used to generate (start up) the virtual computing unit 4 and which is a template defining a configuration of the virtual computing unit 4. The replication controller 3 controls the number of the virtual computing units 4 using a scaling management unit P31.

In this case, the replication controller 3 manages generation and destruction of the virtual computing units 4 for each autoscaling group 5. An autoscaling group 5 refers to a management unit for executing autoscaling. Autoscaling refers to processing for automatically adjusting the number of virtual computing units 4 in accordance with an instruction. The example of FIG. 1 represents a situation where a plurality of autoscaling groups 5 are formed from virtual computing units 4 respectively implemented on different computers 2. Each virtual computing unit 4 in the autoscaling group 5 is generated from the same image 40.

FIG. 1 shows a plurality of autoscaling groups 5(1) and 5(2). A first autoscaling group 5(1) is configured to include a virtual computing unit 4(1) implemented on a computer 2(1) and a virtual computing unit 4(3) implemented on another computer 2(2). A second autoscaling group 5(2) is configured to include a virtual computing unit 4(2) implemented on the computer 2(1) and a virtual computing unit 4(3) implemented on the other computer 2(2). In other words, the autoscaling group 5 can be constituted by virtual computing units 4 implemented on different computers 2.

The management server 1 detects a sign of performance degradation in an information system in which the virtual computing units 4 operate. When a sign of performance degradation is detected, the management server 1 can also notify the detected sign of performance degradation to a system administrator or the like. Furthermore, when a sign of performance degradation is detected, the management server 1 can also issue a prescribed instruction to the replication controller 3 to have the replication controller 3 implement a countermeasure against the performance degradation.

An example of a functional configuration of the management server 1 will be described. For example, the management server 1 can include an operating information acquisition unit P10, a baseline generation unit P11, a performance degradation sign detection unit P12, and a countermeasure implementation unit P13. The functions P10 to P13 are realized by a computer program stored in the management server 1 as will be described later. In FIG. 1, a same reference sign is assigned to a computer program and a function which correspond to each other in order to clarify an example of a correspondence between a computer program and a function. Moreover, the respective functions P10 to P13 may be realized using a hardware circuit in place of, or together with, the computer program.

The operating information acquisition unit P10 acquires, from each computer 2, operating information of each virtual computing unit 4 running on the computer 2. The operating information acquisition unit P10 has acquired information related to the configuration of the autoscaling group 5 from the replication controller 3 and is capable of classifying and managing operating information of the virtual computing units 4 acquired from each computer 2 into autoscaling groups. When the replication controller 3 is capable of gathering operating information of each virtual computing unit 4 from each computer 2, the operating information acquisition unit P10 may acquire operating information of each virtual computing unit 4 via the replication controller 3.

The baseline generation unit P11 is an example of a “reference value generation unit”. The baseline generation unit P11 generates a baseline for each autoscaling group based on the operating information acquired by the operating information acquisition unit P10. The baseline refers to a value used as a reference for detecting a sign of performance degradation of the virtual computing unit 4 (a sign of performance degradation of the information system). The baseline has a prescribed width (an upper limit value and a lower limit value) and, when operating information does not fall within the prescribed width, a determination of a sign of performance degradation can be made.

The baseline includes a total amount baseline and an average baseline. The total amount baseline refers to a reference value calculated from a total amount (a sum) of operating information of all virtual computing units 4 in the autoscaling group 5 and calculated for each autoscaling group. The total amount baseline is compared with a total amount of operating information of virtual computing units 4 in the autoscaling group 5.

The average baseline refers to a reference value calculated from an average of the operating information of the respective virtual computing units 4 in the autoscaling group 5 and is calculated for each autoscaling group. The average baseline is compared with each piece of operating information of each virtual computing unit 4 in the autoscaling group 5.

The performance degradation sign detection unit P12 is an example of a “detection unit”. Hereinafter, the performance degradation sign detection unit P12 may also be referred to as the detection unit P12 or the sign detection unit P12. The performance degradation sign detection unit P12 determines whether or not there is a sign of performance degradation in a target virtual computing unit 4 by comparing the operating information of the virtual computing unit 4 with the baseline.

More specifically, for each autoscaling group 5, the sign detection unit P12 compares the total amount baseline calculated with respect to the autoscaling group 5 with a total amount of operating information of all virtual computing units 4 in the autoscaling group 5. The sign detection unit P12 determines that a sign of performance degradation is not detected when the total amount of operating information falls within the total amount baseline but determines that a sign of performance degradation has been detected when the total amount of operating information deviates from the total amount baseline.

In addition, the sign detection unit P12 respectively compares the average baseline calculated with respect to the autoscaling group 5 with the operating information of each virtual computing unit 4 in the autoscaling group 5. The sign detection unit P12 determines that a sign of performance degradation is not detected when the operating information of the virtual computing unit 4 falls within the average baseline but determines that a sign of performance degradation has been detected when the operating information deviates from the average baseline.

When a sign of performance degradation is detected, the sign detection unit P12 transmits an alert toward a terminal 6 used by a user such as a system administrator.

When the sign detection unit P12 detects a sign of performance degradation, the countermeasure implementation unit P13 implements a prescribed countermeasure in order to address the detected sign of performance degradation.

Specifically, when the total amount of the operating information of the respective virtual computing units 4 in the autoscaling group 5 deviates from the total amount baseline, the countermeasure implementation unit P13 instructs the replication controller 3 to perform scale-out.

A deviation of the total amount of the operating information of the virtual computing units 4 in the autoscaling group 5 from the total amount baseline (for example, when the total amount of operating information exceeds the upper limit of the total amount baseline) means that the number of virtual computing units 4 allocated to processing for which the autoscaling group 5 is responsible is insufficient. In consideration thereof, the countermeasure implementation unit P13 instructs the replication controller 3 to add a prescribed number of virtual computing units 4 to the autoscaling group 5 of which processing capability is apparently insufficient. The replication controller 3 generates the prescribed number of virtual computing units 4 using the image 40 corresponding to the autoscaling group 5 that is a scale-out target, and adds the prescribed number of virtual computing units 4 to the autoscaling group 5 that is the scale-out target.

When the operating information of any of the virtual computing units 4 in the autoscaling group 5 deviates from the average baseline (when the operating information exceeds the upper limit of the average baseline or falls below the lower limit of the average baseline), the countermeasure implementation unit P13 perceives that the virtual computing unit 4 is in an overloaded state, a stopped state, or the like. Therefore, the countermeasure implementation unit P13 instructs the computer 2 providing the virtual computing unit 4 from which the sign has been detected to redeploy. The instructed computer 2 destroys the virtual computing unit 4 from which the sign of performance degradation has been detected, and generates and starts up a new virtual computing unit 4 from the same image 40 as the destroyed virtual computing unit 4.

According to the present embodiment configured as described above, a baseline can be generated from operating information of each virtual computing unit 4 constituting an autoscaling group. As a result, in the present embodiment, a sign of performance degradation can be detected even with respect to an information system in which virtual computing units are Generated and destroyed repeatedly over a short period of time.

In the present embodiment, since the management server 1 spuriously assumes the respective virtual computing units 4 in the autoscaling group 5 that is a management unit of autoscaling to be the same virtual computing unit, operating information necessary for generating a baseline can be acquired. Since the autoscaling group 5 is constituted by virtual computing units 4 generated from a common image 40, there is no harm in considering the virtual computing units 4 in the autoscaling group 5 as one virtual computing unit.

In the present embodiment, by assuming that all of the virtual computing units 4 constituting the autoscaling group 5 are one virtual computing unit 4, the management server 1 can respectively generate a total amount baseline and an average baseline. In addition, by comparing the total amount baseline with the total amount of operating information of the respective virtual computing units 4 in the autoscaling group 5, the management server 1 can detect, in advance, whether an overloaded state or a state of processing capability shortage is about to occur in the autoscaling group 5.

Furthermore, by comparing the average baseline with the operating information of each virtual computing unit 4 in the autoscaling group 5, the management server 1 can individually detect a virtual computing unit 4 having stopped operation or a virtual computing unit 4 with low processing capability in the autoscaling group 5.

By comparing a total amount baseline with total amount operating information, the management server 1 according to the present embodiment can determine a sign of performance degradation for each autoscaling group that is a management unit of containers 4 generated from a same image 40. In addition, by comparing an average baseline with operating information, the management server 1 according to the present embodiment can also individually determine a sign of performance degradation of each virtual computing unit 4 in the autoscaling group 5.

In the present embodiment, since the management server 1 instructs scale-out to be performed with respect to an autoscaling group 5 violating the total amount baseline, occurrences of performance degradation can be suppressed. In addition, since the management server 1 re-creates a virtual computing unit 4 having violated the average baseline, occurrences of performance degradation can be further suppressed. Only one of performance monitoring based on the total amount baseline and a countermeasure thereof and performance monitoring based on the average baseline and a countermeasure thereof may be performed or both may be performed either simultaneously or at different timings.

### Embodiment 1

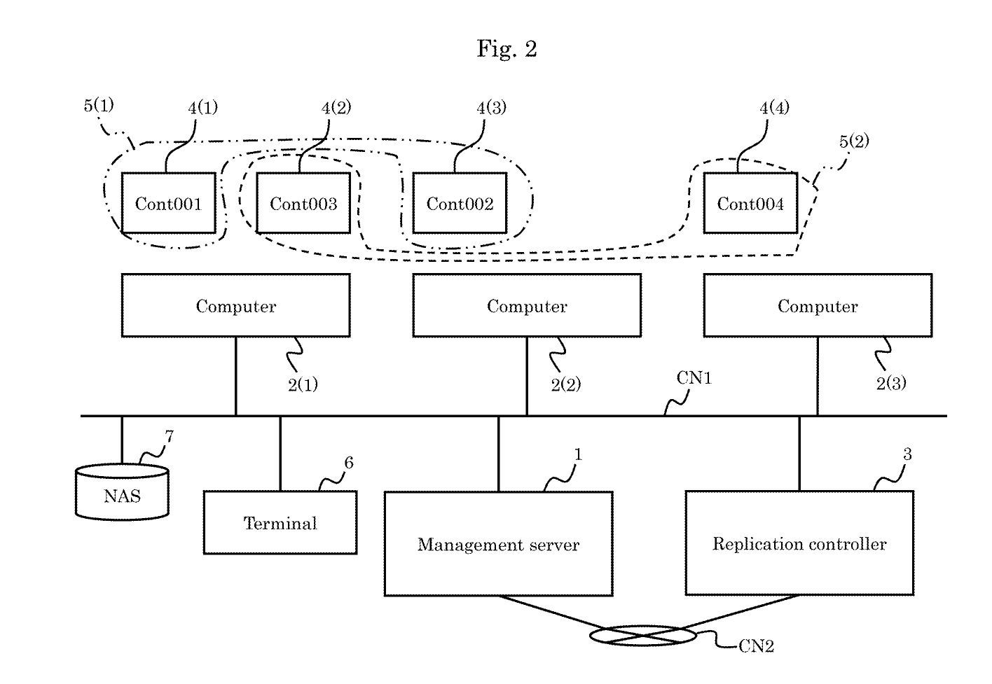

Embodiment 1 will now be described with reference to FIGS. 2 to 17. FIG. 2 is a configuration diagram of an entire system including an information system and the management server 1 which manages performance of the information system.

The entire system includes, for example, at least one management server 1, at least one computer 2, at least one replication controller, a plurality of containers 4, and at least one autoscaling group 5. In addition, the entire system can include the terminal 6 used by a user such as a system administrator and a storage system 7 such as an NAS (Network Attached Storage). In the configuration shown in FIG. 2, at least the computer 2 and the replication controller 3 constitute an information system that is a target of performance management by the management server 1. The respective apparatuses 1 to 3, 6, and 7 are coupled so as to be capable of bidirectionally communicating with each other via, for example, a communication network CN1 that is a LAN (Local Area Network), the Internet, or the like.

The container 4 is an example of the virtual computing unit 4 described with reference to FIG. 1. In order to clarify correspondence, the same reference sign “4” is assigned to containers and virtual computing units. The container 4 is a logical container created using containerization technology. In the following description, the container 4 may also be referred to as a container instance 4.

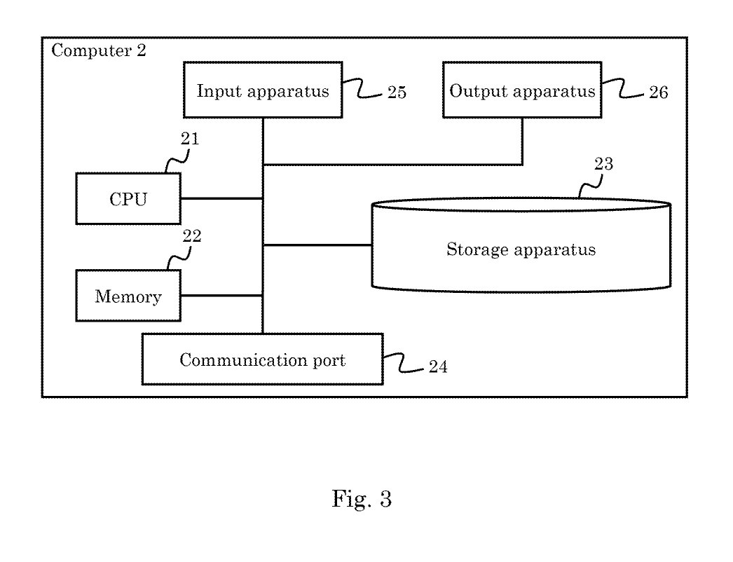

FIG. 3 is a diagram showing a configuration of the computer 2. For example, the computer 2 includes a CPU (Central Processing Unit) 21, a memory 22, a storage apparatus 23, a communication port 24, an input apparatus 25, and an output apparatus 26.

For example, the storage apparatus 23 is constituted by a hard disk drive or a flash memory and stores an operating system, a library, an application program, and the like. By executing a computer program transferred from the storage apparatus 23 to the memory 22, the CPU 21 can start up the container 4 and manage deployment, destruction, and the like of the container 4.

The communication port 24 is for communicating with the management server 1 and the replication controller 3 via the communication network CN1. The input apparatus 25 includes, for example, an information input apparatus such as a keyboard or a touch panel. The output apparatus 26 includes, for example, an information output apparatus such as a display. The input apparatus 25 may include a circuit that receives signals from apparatuses other than the information input apparatus. The output apparatus 26 may include a circuit that outputs signals to apparatuses other than the information output apparatus.

The container 4 runs as a process on the memory 22. When an instruction is received from the replication controller 3 or the management server 1, the computer 2 deploys or destroys the container 4 based on the instruction. In addition, when the computer 2 is instructed by the management server 1 to acquire operating information of the container 4, the computer 2 acquires the operating information of the container 4 and responds to the management server 1.

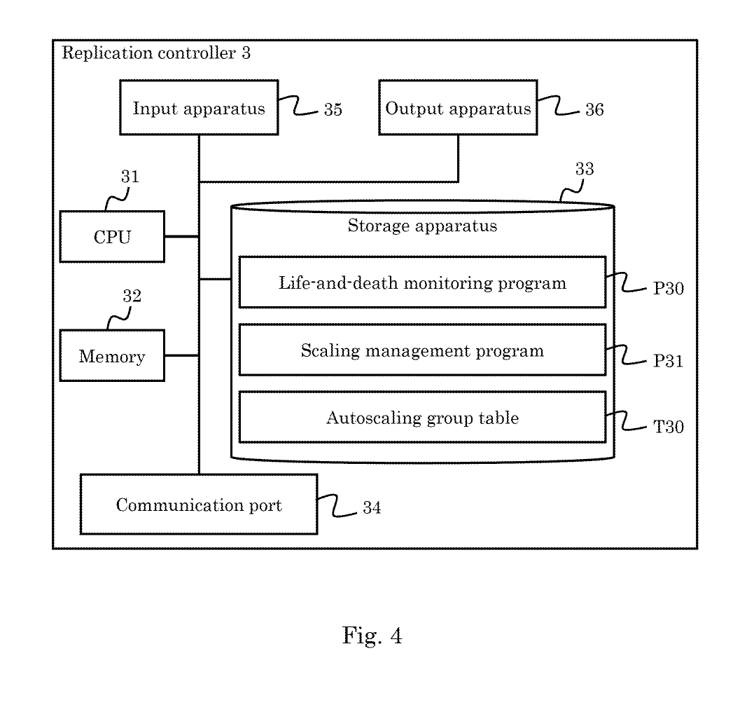

FIG. 4 is a diagram showing a configuration of the replication controller 3. For example, the replication controller 3 can include a CPU 31, a memory 32, a storage apparatus 33, a communication port 34, an input apparatus 35, and an output apparatus 36.

The storage apparatus 33 being constituted by a hard disk drive, a flash memory, or the like stores a computer program and management information. Examples of the computer program include a life-and-death monitoring program P30 and a schedule management program P31. Examples of the management information include an autoscaling group table T30 for managing autoscaling groups.

The CPU 31 realizes functions as the replication controller 3 by reading out the computer program stored in the storage apparatus 33 to the memory 32 and executing the computer program. The communication port 34 is for communicating with the respective computers 2 and the management server 1 via the communication network CN1. The input apparatus 35 is an apparatus that accepts input from the user or the like and the output apparatus 36 is an apparatus that provides the user or the like with information.

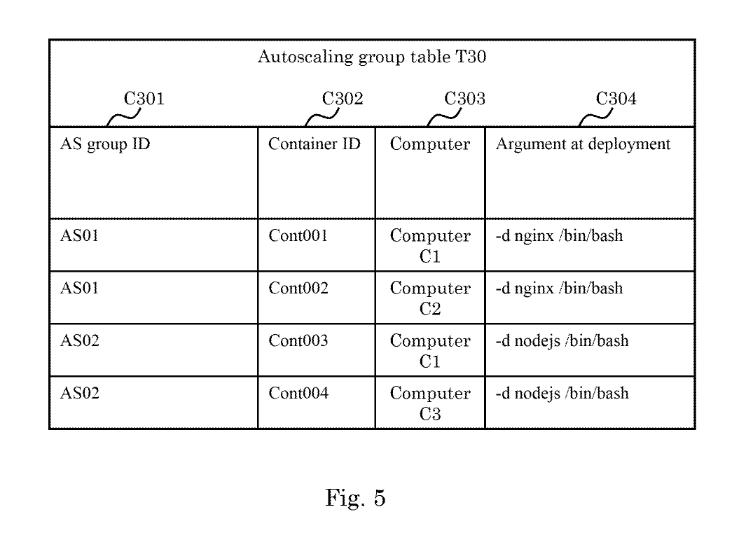

The autoscaling group table T30 will be described using FIG. 5. The autoscaling group table T30 is a table for managing autoscaling groups 5 in the information system. Although the respective tables described below including the present table T30 are management tables, the tables will be simply described as tables.

For example, the autoscaling group table T30 manages an autoscaling group ID C301, a container ID C302, computer information C303, and an argument at deployment C304 in association with each other.

The autoscaling group ID C301 is a field of identification information that uniquely identifies each autoscaling group 5. The container ID C302 is a field of identification information that uniquely identifies each container 4. The computer information C303 is a field of identification information that uniquely identifies each computer 2. The argument at deployment C304 is a field for storing an argument upon deploying the container 4 (container instance). In the autoscaling group table T30, a record is created for each container.

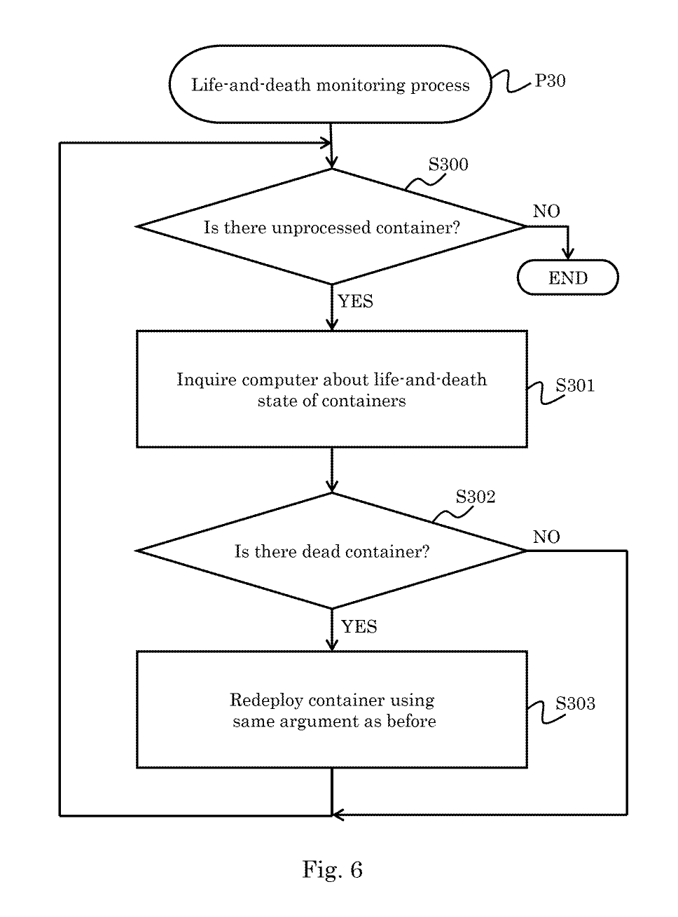

FIG. 6 is a flow chart showing processing by the life-and-death monitoring program P30. The life-and-death monitoring program P30 regularly checks a life-and-death monitoring result for all containers 4 stored in the autoscaling group table T30. Hereinafter, while a description will be given using the life-and-death monitoring program P30 as an operating entity, an alternative description can be given using a life-and-death monitoring unit P30 or the replication controller 3 as the operating entity instead of the life-and-death monitoring program P30.

The life-and-death monitoring program P30 checks whether or not there is a container 4 of which life-and-death has not been checked among the containers 4 stored in the autoscaling group table T30 (S300).

When the life-and-death monitoring program P30 determines that there is a container 4 of which life-and-death has not been checked (S300: YES), the life-and-death monitoring program P30 inquires the computer 2 about the life-and-death of the container 4 (S301). Specifically, the life-and-death monitoring program P30 identifies the computer 2 to which the inquiry regarding life-and-death is to be forward by referring to the container ID 302 field and the computer information C303 field of the autoscaling group table T30. By explicitly polling a container ID to the identified computer 2, the life-and-death monitoring program P30 inquires about the life-and-death of the container 4 having the container ID (S301).

The life-and-death monitoring program P30 determines whether there is a dead container 4 or, in other words, a container 4 that is currently stopped (S302). When the life-and-death monitoring program P30 discovers a dead container 4 (S302: YES), the life-and-death monitoring program P30 refers to the argument at deployment C304 field of the autoscaling group table T30 and deploys the container using the argument configured in the field (S303).

When there is no dead container 4 (S302: NO), the life-and-death monitoring program P30 returns to step S300 and determines whether there remains a container 4 on which life-and-death monitoring has not been completed (S300). Once life-and-death monitoring is completed for all containers 4 (S300: NO), the life-and-death monitoring program P30 ends the present processing.

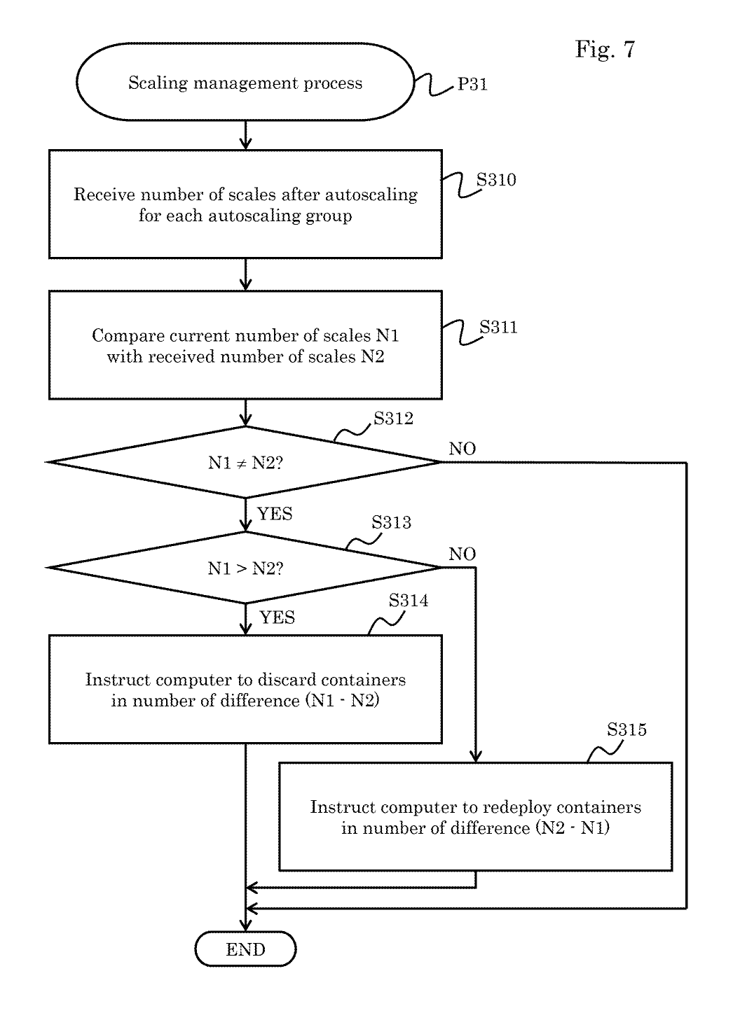

FIG. 7 is a flow chart showing processing of the scaling management program P31. The scaling management program P31 controls a configuration of the autoscaling group 5 in accordance with an instruction input from the management server 1 or the input apparatus 35. Hereinafter, while a description will be given using the scaling management program P31 as an operating entity, an alternative description can be given using a scaling management unit P31 or the replication controller 3 as the operating entity instead of the scaling management program P31.

The scaling management program P31 receives a scaling change instruction including an autoscaling group ID and the number of scales (number of containers) (S310). The scaling management program P31 compares the number of scales N1 of the specified autoscaling group 5 with the instructed number of scales N2 (S311). Specifically, the scaling management program P31 refers to the autoscaling group table T30, comprehends the number of containers 4 currently running in the specified autoscaling group 5 as the current number of scales N1, and compares the number of scales N1 with the received number of scales N2.

The scaling management program P31 determines whether or not the current number of scales N1 and the received number of scales N2 differ from each other (S302). When the current number of scales N1 and the received number of scales N2 are consistent (S312: NO), since the number of scales need not be changed, the scaling management program P31 ends the present processing.

When the current number of scales N1 and the received number of scales N2 differ from each other (S312: YES), the scaling management program P31 determines whether or not the current number of scales N1 is larger than the received number of scales N2 (S313).

When the current number of scales N1 (the number of currently running containers) is larger than the received number of scales N2 (the instructed number of containers) (S313: YES), the scaling management program P31 implements scale-in (S314). Specifically, the scaling management program P31 instructs the computer 2 to destroy the containers 4 in a number corresponding to a difference (=N1−N2) (S314). The scaling management program P31 deletes records corresponding to the destroyed containers 4 from the autoscaling group table T30 (S314).

When the current number of scales N1 is smaller than the received number of scales N2 (S313: NO), the scaling management program P31 implements scale-out (S315). Specifically, the scaling management program P31 instructs the computer 2 to deploy the containers 4 in a number corresponding to a difference (=N2−N1) and add records corresponding to the deployed containers 4 to the autoscaling group table T30 (S315).

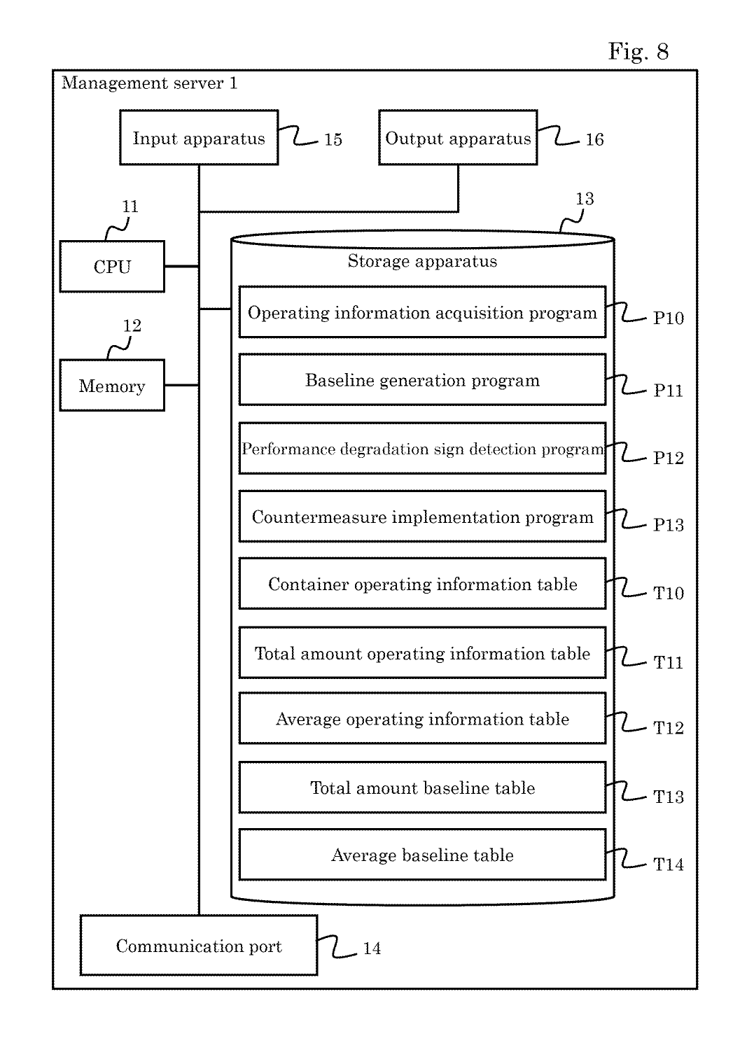

FIG. 8 is a diagram showing a configuration of the management server 1. For example, the management server 1 is configured to include a CPU 11, a memory 12, a storage apparatus 13, a communication port 14, an input apparatus 15, and an output apparatus 16.

The communication port 14 is for communicating with the respective computers 2 and the replication controller 3 via the communication network CN1. The input apparatus 15 is an apparatus that accepts input from the user or the like such as a keyboard or a touch panel. The output apparatus 16 is an apparatus that outputs information to be presented to the user such as a display.

The storage apparatus 13 stores computer programs P11 to P13 and management tables T10 to T14. The computer programs include an operating information acquisition program P10, a baseline generation program P11, a performance degradation sign detection program P12, and a countermeasure implementation program P13. The management tables include a container operating information table T10, a total amount operating information table T11, an average operating information table T12, a total amount baseline table T13, and an average baseline table T14. The CPU 11 realizes prescribed functions for performance management by reading out the computer programs stored in the storage apparatus 13 to the memory 12 and executing the computer programs.

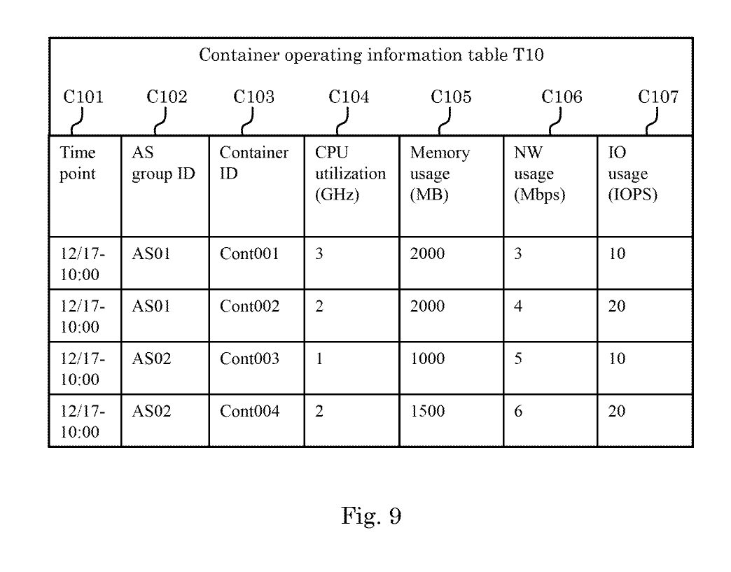

FIG. 9 shows the container operating information table T10. The container operating information table T10 is a table for managing operating information of each container 4. For example, the container operating information table T10 manages a time point C101, an autoscaling group ID C102, a container ID C103, CPU utilization C104, memory usage C105, network usage C106, and IO usage C107 in association with each other. In the container operating information table T10, a record is created for each container.

The time point C101 is a field for storing a time and date when operating information (the CPU utilization, the memory usage, the network usage, and the IO usage) has been measured. The autoscaling group ID C102 is a field for storing identification information that identifies the autoscaling group 5 to which the container 4 that is a measurement target belongs. In the drawing, an autoscaling group may be expressed as an “AS group”. The container ID C103 is a field for storing identification information that identifies the container 4 that is the measurement target.

The CPU utilization C104 is a field for storing an amount (GHz) by which the container 4 utilizes the CPU 21 of the computer 2 and is a type of container operating information. The memory usage C105 is a field for storing an amount (MB) by which the container 4 uses the memory 22 of the computer 2 and is an example of container operating information. The network usage C106 is a field for storing an amount (Mbps) by which the container 4 communicates using the communication network CN1 (or another communication network (not shown)) and is a type of container operating information. In the drawing, a network may be expressed as NW. The IO usage C107 is a field for storing the number (TOPS) by which information is inputted to the container 4 and information is outputted from the container 4 and is a type of container operating information. The pieces of container operating information C104 to C107 shown in FIG. 9 are merely examples and the present embodiment is not limited to the illustrated pieces of container operating information. A part of the illustrated pieces of container operating information may be used or operating information not shown in the drawing may be newly added.

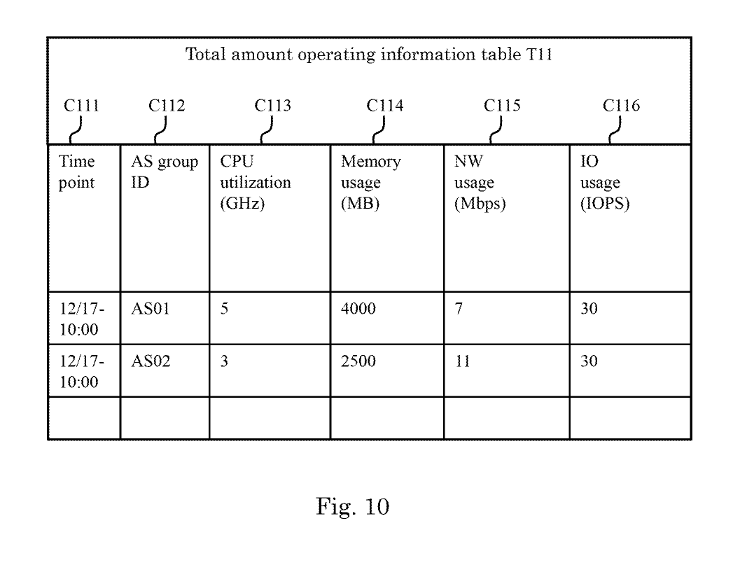

The total amount operating information table T11 will be described using FIG. 10. The total amount operating information table T11 is a table for managing a total amount of operating information of all containers 4 in the autoscaling group 5.

For example, the total amount operating information table T11 manages a time point C111, an autoscaling group ID C112, CPU utilization C113, memory usage C114, network usage C115, and IO usage C116 in association with each other. In the total amount operating information table T11, a record is created for each measurement time point and for each autoscaling group.

The time point C111 is a field for storing a time and date of measurement of operating information (the CPU utilization, the memory usage, the network usage, and the 10 usage). The autoscaling group ID C112 is a field for storing identification information that identifies the autoscaling group 5 that is a measurement target.

The CPU utilization C113 is a field for storing a total amount (GHz) by which the respective containers 4 in the autoscaling group 5 utilize the CPU 21 of the computer 2. The memory usage C114 is a field for storing a total amount (MB) by which the respective containers 4 in the autoscaling group 5 use the memory 22 of the computer 2. The network usage C115 is a field for storing a total amount (Mbps) by which the respective containers 4 in the autoscaling group 5 communicate using the communication network CN1 (or another communication network (not shown)). The IO usage C116 is a field for storing the number (IOPS) of pieces of input information and output information of the respective containers 4 in the autoscaling group 5.

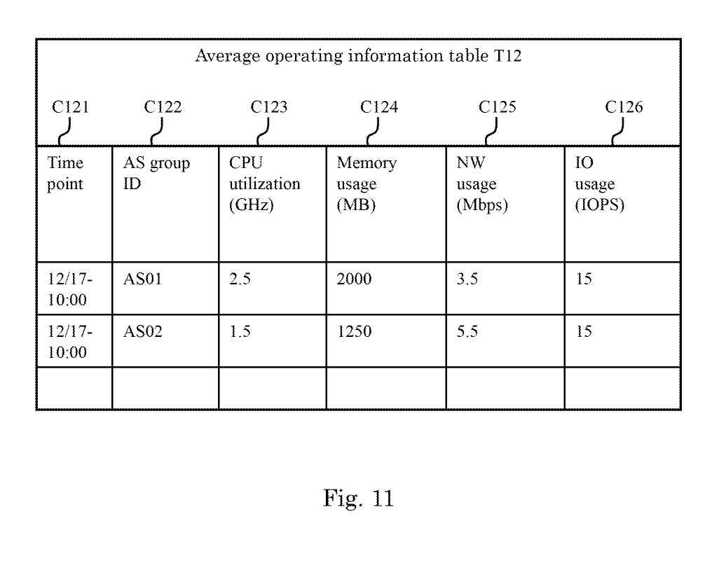

The average operating information table T12 will be described using FIG. 11. The average operating information table T12 is a table for managing an average of operating information of the respective containers 4 in the autoscaling group 5. In the average operating information table T12, a record is created for each measurement time point and for each autoscaling group.

For example, the average operating information table T12 manages a time point C121, an autoscaling group ID C122, CPU utilization C123, memory usage C124, network usage C125, and IO usage C126 in association with each other.

The time point C121 is a field for storing a time and date of measurement of operating information (the CPU utilization, the memory usage, the network usage, and the IO usage). The autoscaling group ID C122 is a field for storing identification information that identifies the autoscaling group 5 that is a measurement target.

The CPU utilization C123 is a field for storing an average (GHz) by which the respective containers 4 in the autoscaling group 5 utilize the CPU 21 of the computer 2. The memory usage C124 is a field for storing an average (MB) by which the respective containers 4 in the autoscaling group 5 use the memory 22 of the computer 2. The network usage C125 is a field for storing an average (Mbps) by which the respective containers 4 in the autoscaling group 5 communicate using the communication network CN1 (or another communication network (not shown)). The IO usage C126 is a field for storing an average number (IOPS) of pieces of input information and output information of the respective containers 4 in the autoscaling group 5.

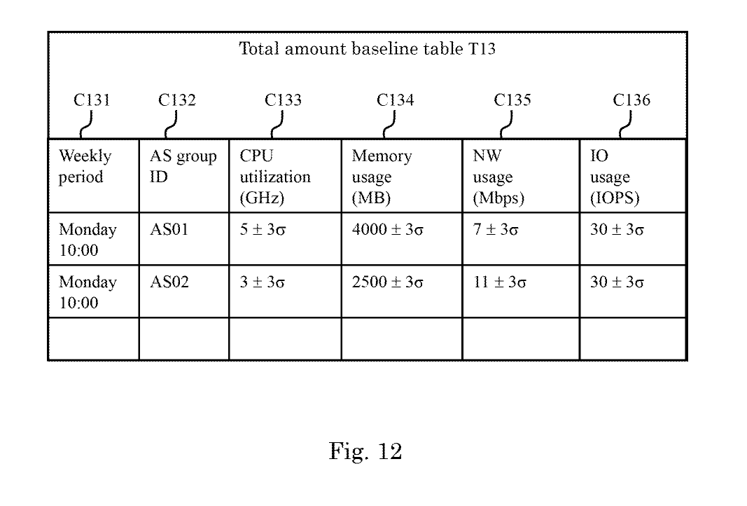

The total amount baseline table T13 will be described using FIG. 12. The total amount baseline table T13 is a table for managing a total amount baseline that is generated based on total amount operating information.

For example, the total amount baseline table T13 manages a weekly period C131, an autoscaling group ID C132, CPU utilization C133, memory usage C134, network usage C135, and IO usage C136 in association with each other. In the total amount baseline table T13, a record is created for each period and for each autoscaling group.

The weekly period C131 is a field for storing a weekly period of a baseline. The example shown in FIG. 12 indicates that a total amount baseline is created every Monday and for each autoscaling group.

The autoscaling group ID C132 is a field for storing identification information that identifies the autoscaling group 5 to be a baseline target. The CPU utilization C133 is a field for storing a baseline of a total amount (GHz) by which the respective containers 4 in the autoscaling group 5 utilize the CPU 21 of the computer 2. The memory usage C134 is a field for storing a baseline of a total amount (MB) by which the respective containers 4 in the autoscaling group 5 use the memory 22 of the computer 2. The network usage C135 is a field for storing a baseline of a total amount (Mbps) by which the respective containers 4 in the autoscaling group 5 communicate using the communication network CN1 (or another communication network (not shown)). The IO usage C136 is a field for storing a baseline of the number (IOPS) of pieces of input information and output information of the respective containers 4 in the autoscaling group 5.

The average baseline table T14 will be described using FIG. 12. The average baseline table T14 is a table for managing an average baseline that is generated based on an average of operating information. In the average baseline table T14, a record is created for each period and for each autoscaling group.

For example, the average baseline table T14 manages a weekly period C141, an autoscaling group ID C142, CPU utilization C143, memory usage C144, network usage C145, and IO usage C146 in association with each other.

The weekly period C141 is a field for storing a weekly period of an average baseline. The autoscaling group ID C142 is a field for storing identification information that identifies the autoscaling group 5 to be a baseline target. The CPU utilization C143 is a field for storing an average baseline (GHz) by which the respective containers 4 in the autoscaling group 5 utilize the CPU 21 of the computer 2. The memory usage C144 is a field for storing an average baseline (MB) by which the respective containers 4 in the autoscaling group 5 use the memory 22 of the computer 2. The network usage C145 is a field for storing an average baseline (Mbps) by which the respective containers 4 in the autoscaling group 5 communicate using the communication network CN1 (or another communication network (not shown)). The IO usage C146 is a field for storing an average baseline (IOPS) of pieces of input information and output information of the respective containers 4 in the autoscaling group 5.

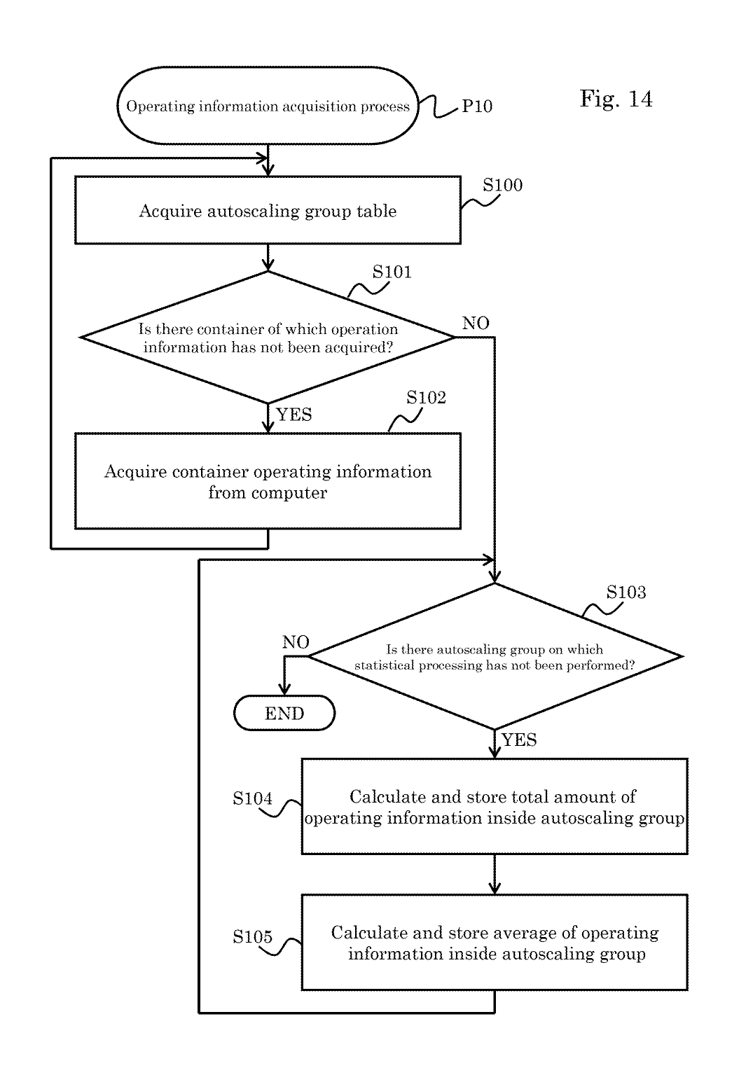

FIG. 14 is a flow chart showing processing by the operating information acquisition program P10. The operating information acquisition program P10 acquires operating information of the container 4 from the computer 2 on a regular basis such as at a fixed time point every week. Hereinafter, while a description will be given using the operating information acquisition program P10 as an operating entity, an alternative description can be given using an operating information acquisition unit P10 or the management server 1 as the operating entity instead of the operating information acquisition program P10.

The operating information acquisition program P10 acquires information of the autoscaling group table T30 from the replication controller 3 (S100). The operating information acquisition program P10 checks whether or not there is a container 4 for which operating information has not been acquired among the containers 4 described in the autoscaling group table T30 (S101).

When there is a container 4 for which operating information has not been acquired (S101: YES), the operating information acquisition Program P10 acquires the operating information of the container 4 from the computer 2 and stores the operating information in the container operating information table T10 (S102), and returns to step S100.

Once the operating information acquisition program P10 acquires operating information from all of the containers 4 (S101: NO), the operating information acquisition program P10 checks whether there is an autoscaling group 5 on which prescribed statistical processing has not been performed (S103). In this case, examples of the prescribed statistical processing include processing for calculating a total amount of the respective pieces of operating information and processing for calculating an average of the respective pieces of operating information.

When there is an autoscaling group 5 that is not been processed (S103: YES), the operating information acquisition program P10 calculates a sum of operating information of the respective containers 4 included in the unprocessed autoscaling group 5 and saves the sum in the total amount operating information table T11 (S104). In addition, the operating information acquisition program P10 calculates an average of operating information of the respective containers 4 included in the unprocessed autoscaling group 5 and saves the average in the average operating information table T12 (S105). Subsequently, the operating information acquisition program P10 returns to step S103.

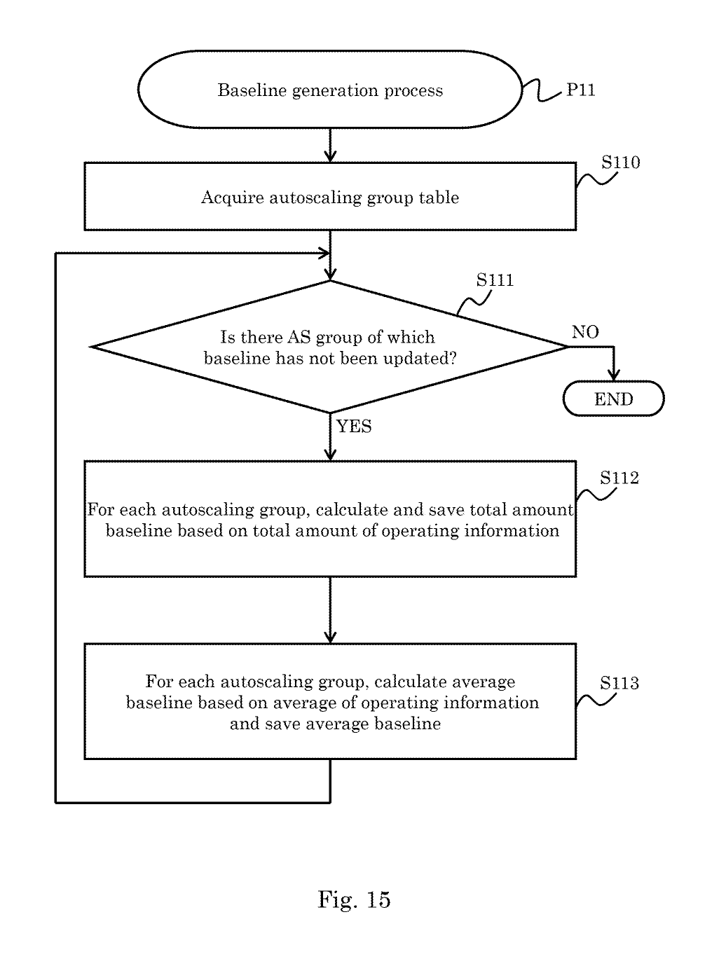

FIG. 15 is a flow chart showing processing by the baseline generation program P11. The baseline generation program P11 periodically generates a total amount baseline and an average baseline for each autoscaling group. While a description will be given using the baseline generation program P11 as an operating entity, an alternative description can be given using a baseline generation unit P11 or the management server 1 as the operating entity instead of the baseline generation program P11.

The baseline generation program P11 acquires information of the autoscaling group table T30 from the replication controller 3 (S110). The baseline generation program P11 checks whether or not there is an autoscaling group 5 of which a baseline has not been updated among the autoscaling groups 5 (S111).

When there is an autoscaling group 5 of which a baseline has not been updated (S111: YES), the baseline generation program P11 generates a total amount baseline using the operating information recorded in the total amount operating information table T11 and saves the total amount baseline in the total amount baseline table T13 (S112).

The baseline generation program P11 generates an average baseline using the operating information in the average operating information table T12, saves the generated average baseline in the average baseline table T14 (S113), and returns to step S111.

Once the total amount baseline and the average baseline are updated with respect to all autoscaling groups 5 (S111: NO), the baseline generation program P11 ends the present processing.

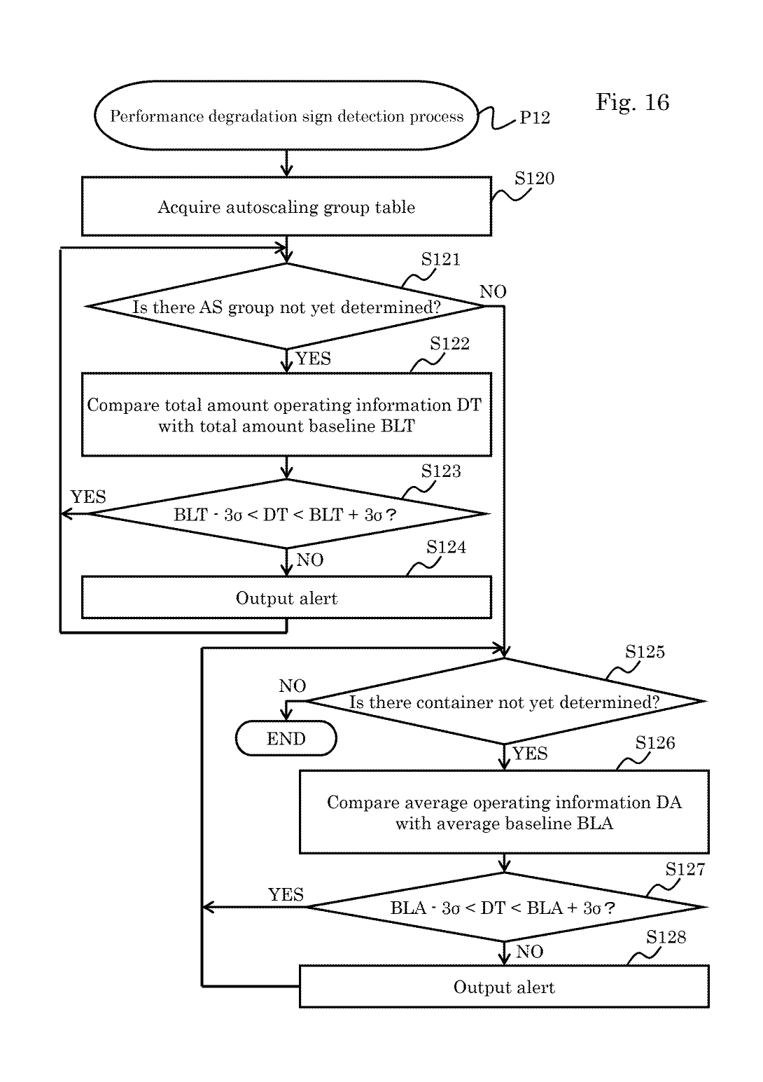

FIG. 16 is a flow chart showing processing by the performance degradation sign detection program P12. When the operating information acquisition program P10 gathers operating information, the performance degradation sign detection program P12 checks whether a sign of performance degradation (performance failure) has not occurred. While a description will be given using the performance degradation sign detection program P12 as an operating entity, an alternative description can be given using a performance degradation sign detection unit P12 or the management server 1 as the operating entity instead of the performance degradation sign detection program P12. Moreover, the performance degradation sign detection program P12 may also be referred to as a sign detection program P12.

The performance degradation sign detection program P12 acquires information of the autoscaling group table T30 from the replication controller 3 (S120). The sign detection program P12 checks whether or not there is an autoscaling group 5 for which a sign of performance degradation has not been determined among the respective autoscaling groups 5 (S121).

When there is an autoscaling group 5 that is yet to be determined (S121: YES), the sign detection program P12 compares a total amount baseline stored in the total amount baseline table T13 with total amount operating information stored in the total amount operating information table T11 (S122). Moreover, in the drawing, total amount operating information may be abbreviated to “DT” and a median of a total amount baseline may be abbreviated to “BLT”.

The sign detection program P12 checks whether a value of the total amount operating information of the autoscaling group 5 falls within a range of the total amount baseline (S123). As shown in FIG. 12, for example, the total amount baseline has a width of ±3σ with respect to the median thereof. A value obtained by subtracting 3σ from the median is a lower limit value and a value obtained by adding 3σ to the median is an upper limit value.

When the value of the total amount operating information falls within the range of the total amount baseline (S123: YES), the sign detection program P12 returns to step S121. When the value of the total amount operating information does not fall within the range of the total amount baseline (S123: NO), the sign detection program P12 issues an alert for a total amount baseline violation indicating that a sign of performance degradation has been detected (S124), and returns to step S121.

In other words, the sign detection program P12 monitors whether or not the value of the total amount operating information is outside of the range of the total amount baseline (S123), and outputs an alert when the value of the total amount operating information is outside of the range of the total amount baseline (S124).

Once the sign detection program P12 finishes determining whether or not there is a sign of performance degradation with respect to all of the autoscaling groups 5 (S121: NO), the sign detection program P12 checks whether there is a container 4 for which a sign of performance degradation has not been determined among the respective containers 4 (S125).

When there is a container 4 that is yet to be determined (S125: YES), the sign detection program P12 compares an average baseline stored in the average baseline table T14 with operating information stored in the container operating information table T10 (S126). In the drawing, average operating information may be abbreviated to “DA” and an average baseline may be abbreviated to “BLA”.

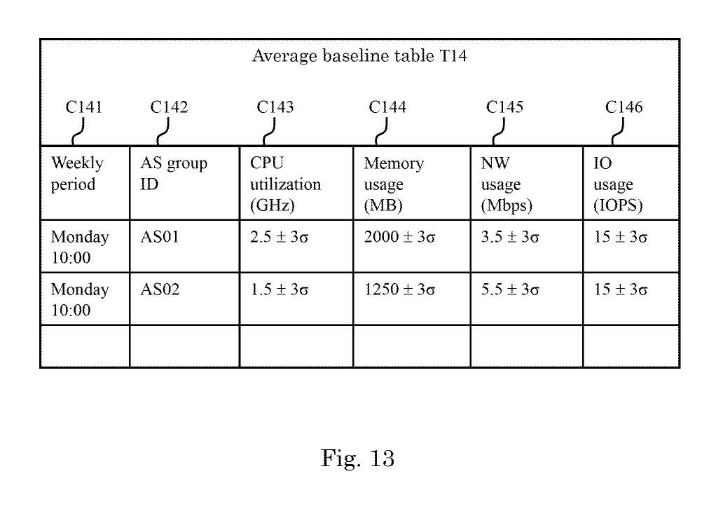

The sign detection program P12 checks whether a value of the operating information of the container 4 falls within a range of the average baseline (S127). As shown in FIG. 13, for example, the average baseline has a width of ±3σ with respect to the median thereof. A value obtained by subtracting 3σ from the median is a lower limit value and a value obtained by adding 3σ to the median is an upper limit value.

When the value of the operating information falls within the range of the average baseline (S127: YES), the sign detection program P12 returns to step S125. When the value of the operating information does not fall within the range of the average baseline (S127: NO), the sign detection program P12 issues an alert for an average baseline violation indicating that a sign of performance degradation has been detected (S128), and returns to step S125.

In other words, the sign detection program P12 monitors whether or not the value of the operating information is outside of the range of the average baseline (S127), and outputs an alert when the value of the operating information is outside of the range of the average baseline (S128).

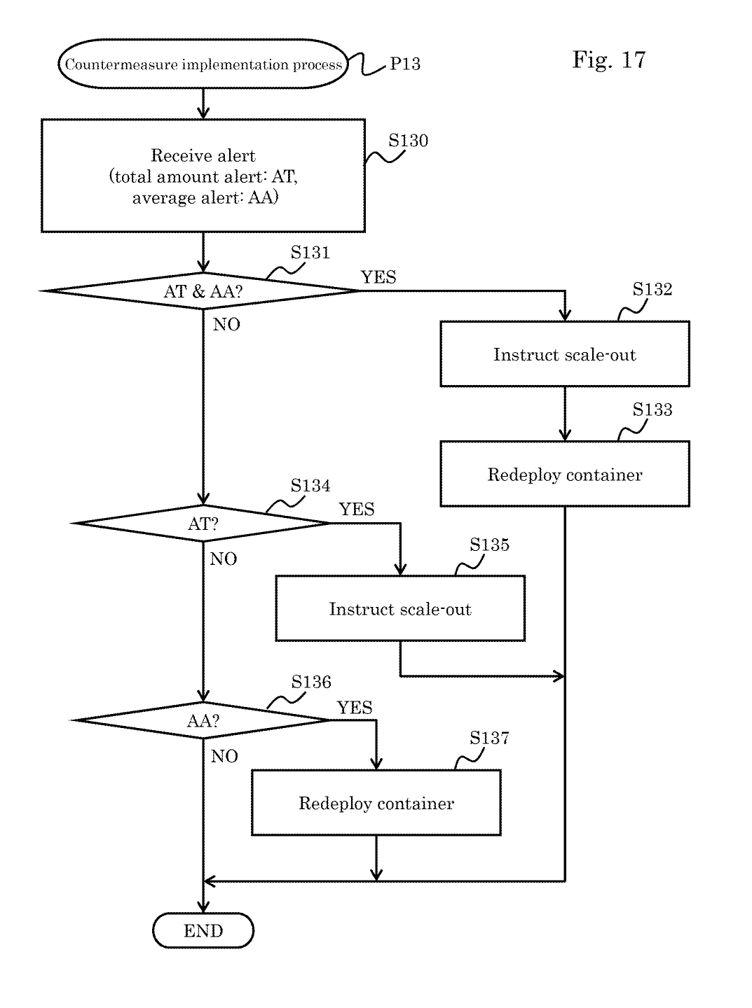

FIG. 17 is a flow chart showing processing by the countermeasure implementation program P13. When the countermeasure implementation program P13 receives an alert issued by the performance degradation sign detection program P12, the countermeasure implementation program P13 implements a countermeasure that conforms to the alert. While a description will be given using the countermeasure implementation program P13 as an operating entity, an alternative description can be given using a countermeasure implementation unit P13 or the management server 1 as the operating entity instead of the countermeasure implementation program P13.

The countermeasure implementation program P13 receives an alert issued by the performance degradation sign detection program P12 (S130). In the drawing, an alert for a total amount baseline violation (also referred to as a total amount alert) may be abbreviated to “AT” and an alert for an average baseline violation (also referred to as an average alert) may be abbreviated to “AA”.

The countermeasure implementation program P13 determines whether a type of the received alert is both an alert for a total amount baseline violation and an alert for an average baseline violation (S131). When the countermeasure implementation program P13 receives both an alert for a total amount baseline violation and an alert for an average baseline violation at the same time (S131: YES), the countermeasure implementation program P13 respectively implements prescribed countermeasures to respond to the respective alerts.

Specifically, in order to respond to the alert for the total amount baseline violation, the countermeasure implementation program P13 issues a scale-out instruction to the replication controller 3 (S132). When the replication controller 3 executes scale-out with respect to the autoscaling group 5 for which the alert for the total amount baseline violation had been issued, since the container 4 is newly added to the autoscaling group 5, processing capability as an autoscaling group is improved.

Subsequently, in order to respond to the alert for the average baseline violation, the countermeasure implementation program P13 issues an instruction to re-create the container 4 for which the alert had been issued to the computer 2 that includes the container 4 (S133).

Specifically, the countermeasure implementation program P13 causes the computer 2 to newly generate the container 4 using a same argument (a same image 40) as the container 4 for which the alert had been issued. In addition, the countermeasure implementation program P13 discards the container 4 having caused the alert.

When the countermeasure implementation program P13 does not receive both an alert for a total amount baseline violation and an alert for an average baseline violation at the same time (S131: NO), the countermeasure implementation program P13 checks whether an alert for a total amount baseline violation has been received in step S130 (S134).

When the alert received in step S130 is an alert for a total amount baseline violation (S134: YES), the countermeasure implementation program P13 instructs the replication controller 3 to execute scale-out (S135).

When the alert received in step S130 is not an alert for a total amount baseline violation (S134: NO), the countermeasure implementation program P13 checks whether the alert is an alert for an average baseline violation (S136).

When the alert received in step S130 is an alert for an average baseline violation (S136: YES), the countermeasure implementation program P13 instructs the computer 2 to re-create the container 4. Specifically, in a similar manner to the description of step S133, the countermeasure implementation program P13 instructs the computer 2 to re-create the container 4 using a same argument as the container having caused the occurrence of the alert for an average baseline violation. In addition, the countermeasure implementation program P13 instructs the computer 2 to discard the container having caused the occurrence of the alert for an average baseline violation.

According to the present embodiment configured as described above, even in an information system with an environment where a lifetime of a container 4 (instance) that is a monitoring target is shorter than a lifetime of a baseline, a baseline can be generated, a sign of performance degradation can be detected using the baseline, and a response to the sign of performance degradation can be made in advance.

In other words, in the present embodiment, even in an environment where a lifetime of the container 4 is too short to create a baseline, since it is spuriously assumed when creating a baseline that the respective containers 4 belonging to a same autoscaling group 5 are the same container 4, a baseline for predicting performance degradation can be obtained. Accordingly, since a sign of degradation of the performance of an information system can be detected, reliability is improved.

Since the autoscaling group 5 is constituted only by containers 4 generated from the same image 40, from the perspective of creating a baseline, the respective containers 4 in the same autoscaling group 5 can be considered the same container.

In the present embodiment, by comparing a total amount baseline and total amount operating information with each other, a sign of performance degradation per autoscaling group can be detected and, furthermore, by comparing an average baseline and the operating information of each container 4 with each other, a sign of performance degradation per container can be detected. Therefore, a sign of performance degradation can be detected in any one of or both of a per-autoscaling group basis and a per-container basis.

In the present embodiment, when a sign of performance degradation is detected, since a countermeasure suitable for the sign can be automatically implemented, degradation of performance can be suppressed in advance and reliability is improved.

Moreover, while the replication controller 3 and the management server 1 are constituted by separate computers in the present embodiment, alternatively, a configuration may be adopted in which processing by a replication controller and processing by a management server are executed on a same computer.

In addition, while the container 4 that is a logical entity is considered a monitoring target in the present embodiment, a monitoring target is not limited to the container 4 and may be a virtual server or a physical server (a bare metal). In this case, a deployment on a physical server is launched using an OS image on an image management server by means of a network boot mechanism such as PXE (Preboot Execution Environment).

Furthermore, while operating information that is a monitoring target in the present embodiment includes CPU utilization, memory usage, network usage, and IO usage, types of operating information are not limited thereto and other types that can be acquired as operating information may be used.

### Embodiment 2

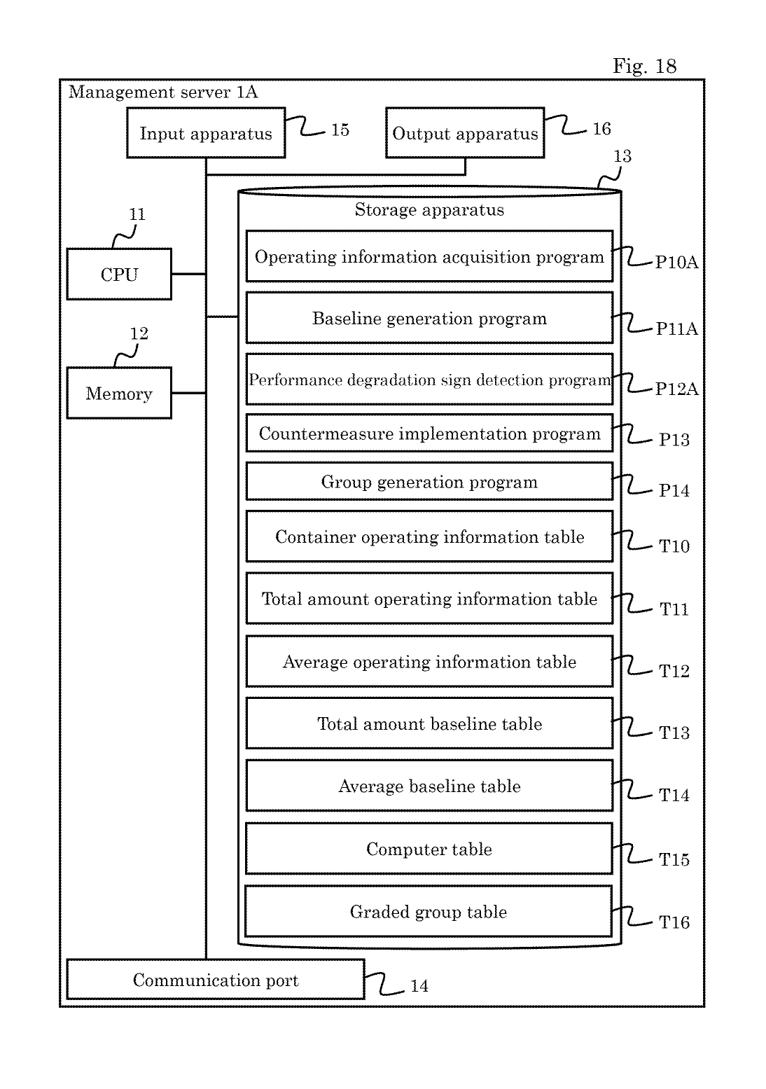

Embodiment 2 will now be described with reference to FIGS. 18 to 21. Since the following embodiments including the present embodiment correspond to modifications of Embodiment 1, a description thereof will focus on differences from Embodiment 1. In the present embodiment, groups for creating a baseline are managed in consideration of a difference in performance among respective computers 2 in which containers 4 are implemented.

FIG. 18 shows a configuration example of a management server 1A according to the present embodiment. While the configuration of the management server 1A according to the present embodiment is almost similar to that of the management server 1 described with reference to FIG. 8, computer programs P10A, P11A, and P12A stored in the storage apparatus 13 differ from the computer programs P10, P11, and P12 according to Embodiment 1. In addition, in the management server 1A according to the present embodiment, a group generation program P14, a computer table T15, and a graded group table T16 are stored in the storage apparatus 13.

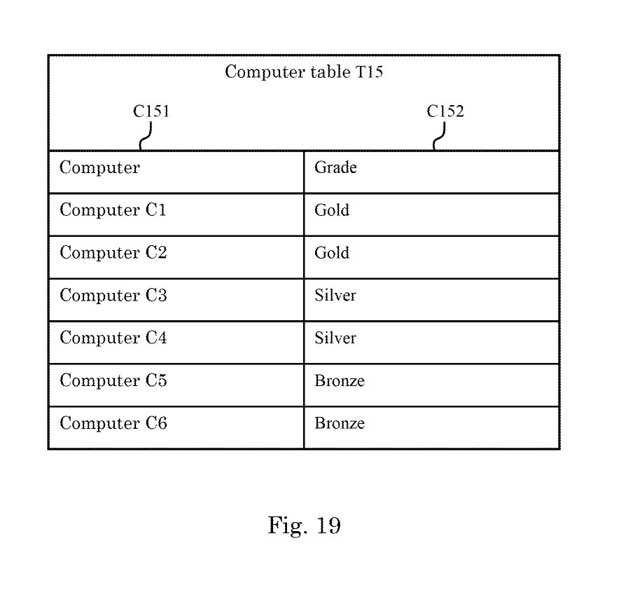

FIG. 19 shows a configuration of the computer table T15 for managing grades of the respective computers 2 in an information system. For example, the computer table T15 is configured so as to associate a field C151 for storing computer information that uniquely identifies a computer 2 with a field C152 for storing a grade that represents performance of the computer 2. In the computer table T15, a record is created for each computer.

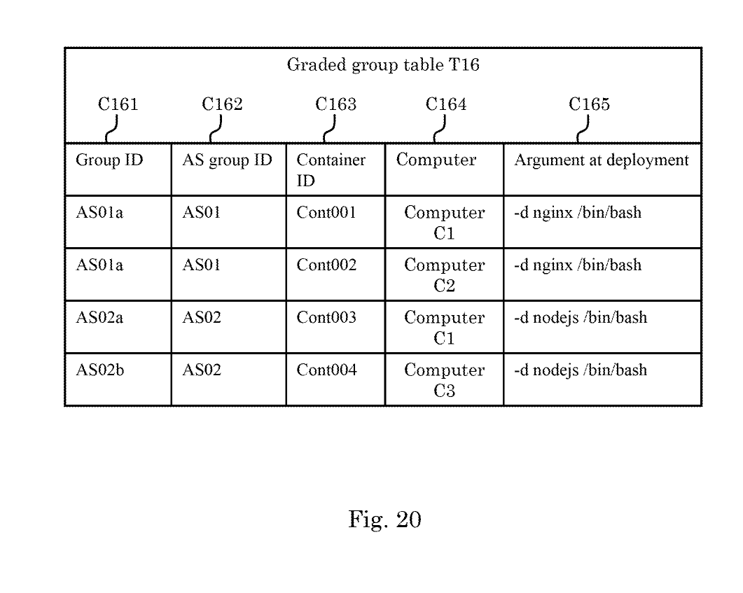

FIG. 20 shows a configuration of the graded group table T16 for managing the computers 2 in the same autoscaling group 5 by dividing the computers 2 according to grades. A graded group refers to a virtual autoscaling group that is formed by classifying the computers 2 belonging to the same autoscaling group 5 according to grades.

For example, the graded group table T16 manages a group ID C161, an autoscaling group ID C162, a container ID C163, computer information C164, and an argument at deployment C165 in association with each other.

The group ID C161 is identification information that uniquely identifies a graded group existing in the autoscaling group 5. The autoscaling group ID C162 is identification information that uniquely identifies the autoscaling group 5. The container ID C163 is identification information that uniquely identifies the container 4. The computer information C164 is information that identifies the computer 2 in which the container 4 is implemented. The argument at deployment C165 is management information used when re-creating the container 4 identified by the container ID C163. In the graded group table T16, a record is created for each container.

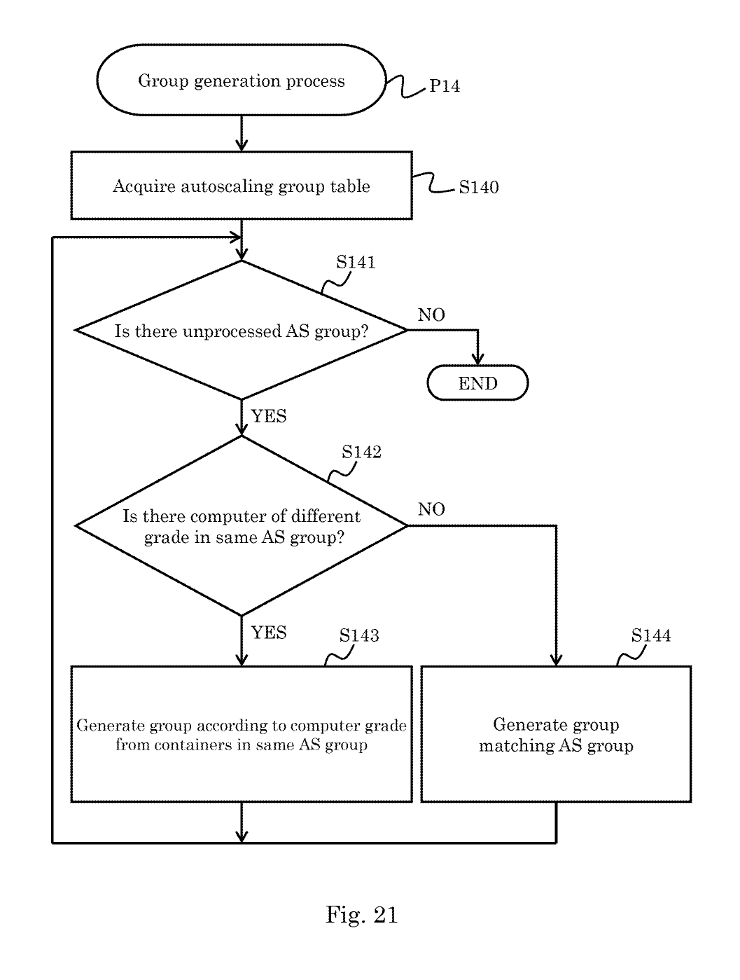

FIG. 21 is a flow chart showing processing by the group generation program P14. While a description will be given using the group generation program P14 as an operating entity, an alternative description can be given using a group generation unit P14 or the management server 1A as the operating entity instead of the group generation program P14.

The Group generation program P14 acquires information of the autoscaling group table T30 from the replication controller 3 (S140). The group generation program P14 checks whether or not there is an autoscaling group 5 of which a graded group has not been generated among the autoscaling groups 5 (S141).

When there is an autoscaling group 5 on which a graded group generation process has not been performed (S141: YES), the group generation program P14 checks whether containers 4 implemented on computers 2 of different grades are included in the autoscaling group 5 (S142). Specifically, by collating the computer information field C303 of the autoscaling group table T30 with the computer information field C151 of the computer table T15, the group generation program P14 determines whether there is a container using a computer of a different grade in a same autoscaling group (S142).

When there is a container 4 using a computer 2 of a different grade in the same autoscaling group (S142: YES), the group generation program P14 creates a graded group from containers 4 which belong to the same autoscaling group and which use computers of a same grade (S143).

When there is not a container 4 using a computer 2 of a different grade in the same autoscaling group (S142: NO), the group generation program P14 creates a graded group by a grouping that matches the autoscaling group (S144). While a graded group is generated as a formality in step S144, the formed graded group is actually the same as the autoscaling group.

The group generation program P14 returns to step S141 to check whether or not there is an autoscaling group 5 on which a graded group generation process has not been performed among the autoscaling groups 5. Once the group generation program P14 performs a graded group generation process on all autoscaling groups 5 (S141: NO), the group generation program P14 ends the processing.

An example shown in FIGS. 19 and 20 will now be described. The containers 4 with the container IDs “Cont001” and “Cont002” share a same autoscaling group ID “AS01” and also share a same grade of the computer 2 of “Gold”. Therefore, the two containers 4 having the container IDs “Cont001” and “Cont002” both belong to a same graded group “AS01a”.

In contrast, two containers (Cont003 and Cont004) included in an autoscaling group “AS02” have different grades of the computer 2. Although the grade of a computer (C1) in which is implemented one container (Cont003) is “Gold”, the grade of a computer (C3) in which is implemented the other container (Cont004) is “Silver”.

Therefore, the autoscaling group “AS02” is virtually divided into graded groups “AS02a” and “AS02b”. Generation of baselines, detection of signs of performance degradation, and the like are executed in units of autoscaling groups divided by grades.

The present embodiment configured as described above produces similar operational advantages to Embodiment 1. In the present embodiment, groups with different computer grades are virtually generated in a same autoscaling group, and a baseline and the like are generated in units of the graded autoscaling groups. Accordingly, with the present embodiment, a total amount baseline and an average baseline can be generated from a group of containers that run on computers with uniform performances. As a result, according to the present embodiment, even in an information system which is constituted by computers with performances that are not uniform and which has an environment where a lifetime of a container that is a monitoring target is shorter than a lifetime of a baseline, a baseline can be generated, a sign of performance degradation can be detected using the baseline, and a response to the sign of performance degradation can be made in advance.

### Embodiment 3

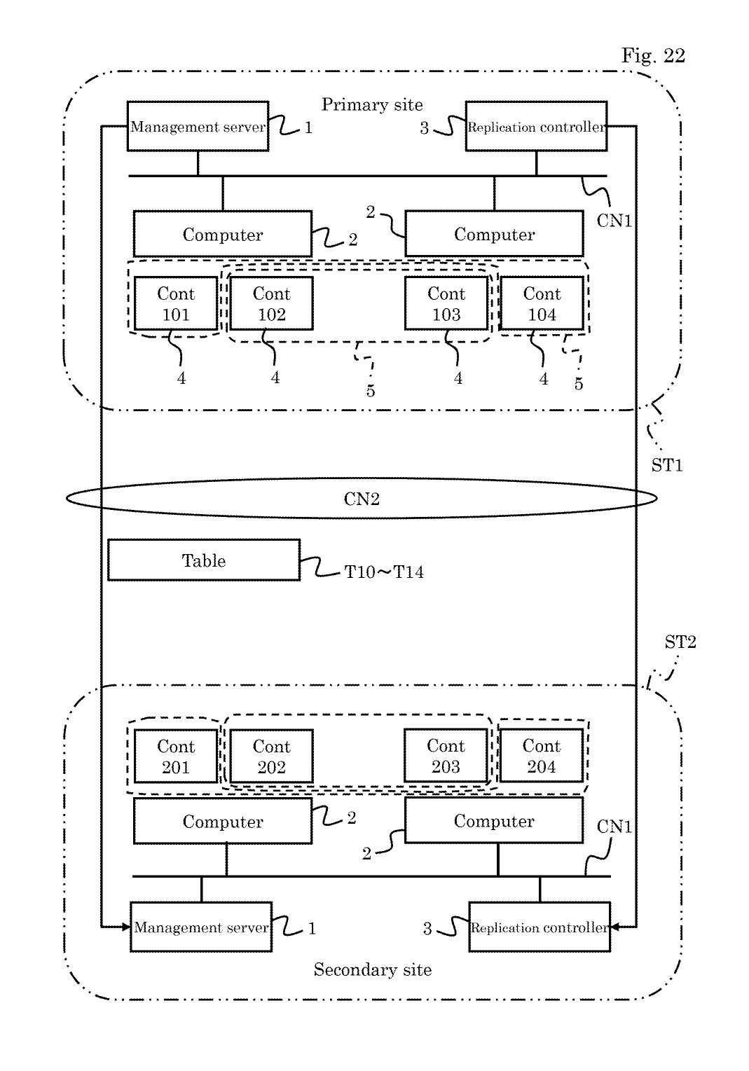

Embodiment 3 will now be described with reference to FIG. 22. In the present embodiment, a case where operating information or the like is inherited between sites will be described.

FIG. 22 is an overall diagram of a failover system which switchably connects a plurality of information systems. A primary site ST1 that is normally used and a secondary site ST2 that is used in abnormal situations are connected to each other via an inter-site network CN2. Since internal configurations of the sites are basically the same, a description thereof will be omitted.

When any kind of failure occurs, the system running is switched from the primary site ST1 to the secondary site ST2. Even in normal times, the secondary site ST2 can include a same container group as a container group that had been running on the primary site ST1 (hot standby). Alternatively, when a failure occurs, the secondary site ST2 can start up a same container group as the container group that had been running on the primary site ST1 (cold standby).

When switching from the primary site ST1 to the secondary site ST2, the container operating information table T10 and the like are transmitted from the management server 1 of the primary site ST1 to the management server 1 of the secondary site ST2. Accordingly, the management server 1 of the secondary site ST2 can promptly generate a baseline and detect a sign of performance degradation with respect to a container group with no operation history.

By transmitting the total amount operating information table T11, the average operating information table T12, the total amount baseline table T13, and the average baseline table T14 from the primary site ST1 to the secondary site ST2 in addition to the container operating information table T10, a load of arithmetic processing on the management server 1 of the secondary site ST2 can be reduced.

The present embodiment configured as described above produces similar operational advantages to Embodiment 1. In addition, by applying the present embodiment to a failover system, monitoring of a sign of performance degradation can be promptly started upon a failover and reliability is improved. Moreover, when a failure is restored and switching is performed from the secondary site ST2 to the primary site ST1 (upon a fallback), the container operating information table T10 and the like of the secondary site ST2 can also be transmitted from the management server 1 of the secondary site ST2 to the management server 1 of the primary site ST1. Accordingly, even when switching to the primary site ST1, detection of a sign of performance degradation can be started at an early stage.

It is to be understood that the present invention is not limited to the embodiments described above and is intended to cover various modifications. For example, the respective embodiments have been described in order to provide a clear understanding of the present invention and the present invention need not necessarily include all of the components described in the embodiments. At least a part of the components described in the embodiments can be modified to other components or can be deleted. In addition, new components can be added to the embodiments.

A part of or all of the functions and processing described in the embodiments maybe realized as a hardware circuit or may be realized as software. Storage of computer programs and various kinds of data is not limited to a storage apparatus inside a computer and may be handled by a storage apparatus outside of the computer.

### REFERENCE SIGNS LIST

1, 1A Management server (management computer)
2 Computer
3 Replication controller
4 Container (virtual computing unit)
5 Autoscaling group
40 Image
P10 Operating information acquisition unit
P11 Baseline generation unit
P12 Performance degradation sign detection unit
P13 Countermeasure implementation unit

1. A management computer which detects and manages a sign of performance degradation of an information system including one or more computers and one or more virtual computing units virtually implemented on the one or more computers, the management computer comprising:
an operating information acquisition unit configured to acquire operating information from all virtual computing units belonging to an autoscaling group, the autoscaling group being a unit of management for autoscaling of automatically adjusting the number of virtual computing units;
a reference value generation unit configured to generate, from each piece of the operating information acquired by the operating information acquisition unit, a reference value that is used for detecting a sign of performance degradation for each autoscaling group; and
a detection unit configured to detect a sign of degradation of the performance of each virtual computing unit using both the reference value generated by the reference value generation unit and the operating information about the virtual computing unit as acquired by the operating information acquisition unit.

2. The management computer according to claim 1, wherein
the reference value generation unit is configured to generate, for each autoscaling group, an average reference value as the reference value, based on an average of operating information of all virtual computing units belonging to the autoscaling group.

3. The management computer according to claim 2, wherein
the detection unit is configured to detect, for each autoscaling group, a sign of performance degradation by comparing operating information of each virtual computing unit belonging to the autoscaling group with the average reference value.

4. The management computer according to claim 3, comprising
a countermeasure implementation unit configured to implement a countermeasure against performance degradation, of which a sign is detected, wherein
when the detection unit determines that a sign of performance degradation is detected with respect to a virtual computing unit of which operating information deviates from the average reference value among all virtual computing units of the autoscaling group, the countermeasure implementation unit is configured to re-start the virtual computing unit.

5. The management computer according to claim 4, wherein
the reference value generation unit is configured to generate, for each autoscaling group, a total amount reference value as the reference value, based on a total amount of operating information of all virtual computing units belonging to the autoscaling group.

6. The management computer according to claim 5, wherein
the detection unit is configured to detect, for each autoscaling group, a sign of performance degradation by comparing a total amount of operating information of all virtual computing units belonging to the autoscaling group with the total amount reference value.

7. The management computer according to claim 6, comprising
a countermeasure implementation unit configured to implement a countermeasure against performance degradation of which a sign is detected, wherein
when the detection unit detects that the total amount of operating information deviates from the total amount reference value and detects a sign of performance degradation, the countermeasure implementation unit is configured to instruct execution of scale-out.

8. The management computer according to claim 1, wherein
the reference value generation unit is configured to:
generate, for each autoscaling group, a total amount reference value as the reference value, based on a total amount of operating information of all virtual computing units belonging to the autoscaling group; or
generate, for each autoscaling group, an average reference value as the reference value, based on an average of operating information of all virtual computing units belonging to the autoscaling group,
the detection unit is configured to:
detect, for each autoscaling group, a sign of performance degradation by comparing a total amount of operating information of all virtual computing units belonging to the autoscaling group with the total amount reference value; or
detect, for each autoscaling group, a sign of performance degradation by comparing operating information of each virtual computing unit belonging to the autoscaling group with the average reference value,
the management computer further comprising a countermeasure implementation unit configured to implement a countermeasure against performance degradation of which a sign is detected,
the countermeasure implementation unit being configured to:
when the detection unit detects that the total amount of operating information deviates from the total amount reference value and detects a sign of performance degradation, instruct execution of scale-out; and
when the detection unit determines that a sign of performance degradation is detected with respect to a virtual computing unit of which operating information deviates from the average reference value among all virtual computing units of the autoscaling group, re-start the virtual computing unit.

9. The management computer according to claim 1, wherein
the virtual computing unit in the autoscaling group is generated from same startup management information.

10. The management computer according to claim 1, wherein
the reference value generation unit is configured to generate, when computers of different performances are included in the autoscaling group, a reference value for detecting a sign of performance degradation with respect to a group classified by performance of the computers in the autoscaling group.

11. The management computer according to claim 10, wherein at least the reference value is transmitted to a management computer of another site before start of a failover.

12. A performance degradation sign detection method of detecting and managing by a management computer a sign of performance degradation of an information system including one or more computers and one or more virtual computing units virtually implemented on the one or more computers, the method comprising, with the use of the management computer:
a step of acquiring operating information from all virtual computing units belonging to an autoscaling group, the autoscaling group being a unit of management for autoscaling of automatically adjusting the number of virtual computing units;
a step of generating, from each piece of acquired operating information, a reference value that is used for detecting a sign of performance degradation for each autoscaling group; and
a step of detecting a sign of degradation of the performance of each virtual computing unit by using both the generated reference value and the acquired operating information of the virtual computing units.

13. The performance degradation sign detection method according to claim 12, further comprising
a step of implementing a countermeasure against performance degradation of which a sign is detected.

14. The performance degradation sign detection method according to claim 13, wherein
in the step of generating the reference value, for each autoscaling group, a total amount reference value as the reference value is generated based on a total amount of operating information of all virtual computing units belonging to the autoscaling group,
in the step of detecting a sign of performance degradation, for each autoscaling group, a sign of performance degradation is detected by comparing a total amount of operating information of all virtual computing units belonging to the autoscaling group with the total amount reference value, and
in the step of implementing a countermeasure against performance degradation, execution of scale-out is instructed when the total amount of operating information deviates from the total amount reference value and a sign of performance degradation is detected.

15. The performance degradation sign detection method according to claim 13, wherein
in the step of generating the reference value, for each autoscaling group, an average reference value as the reference value is generated based on an average of operating information of all virtual computing units belonging to the autoscaling group,
in the step of detecting a sign of performance degradation, for each autoscaling group, a sign of performance degradation is detected by comparing operating information of each virtual computing unit belonging to the autoscaling group with the average reference value, and
in the step of implementing a countermeasure against performance degradation, when a sign of performance degradation is detected with respect to a virtual computing unit of which operating information deviates from the average reference value among all virtual computing units of the autoscaling group, the virtual computing unit is re-started.
